(19) United States
(12) Patent Application Publication
(10) Pub. No.: US 2016/0176410 A1
(43) Pub. Date: Jun. 23, 2016

(54) DRIVER MONITORING SYSTEM

(71) Applicant: Ziad Darowich, Painesville, OH (US)

(72) Inventor: Ziad Darowich, Painesville, OH (US)

(21) Appl. No.: 14/573,266

(22) Filed: Dec. 17, 2014

(51) Int. Cl. B60W 40/09

(52) U.S. Cl. CPC B60W 40/09

(57) ABSTRACT

A system and method for monitoring the performance of a driver of a vehicle and sending a monitor's performance report to a subscriber. The system includes means for uploading one or more subscribers' account information to a data server machine, which contains a computer including a processor, non-transitory memory, a hard disk, a standard application interface and a database stored thereon. Further, the system includes means for issuing a unique vehicle identification code by the data server machine to each of the one or more subscribers. The system further includes means for uploading the monitor's performance report corresponding to the unique vehicle identification code to the data server machine. The system further includes means for notifying the subscriber of the monitor's performance report uploaded to the data server machine. Finally, the system includes means for making the performance report accessible to the subscriber.

### FIELD OF THE INVENTION

The present invention relates to a driver monitoring system and more particularly to a system and method for monitoring the performance of a driver of a vehicle and sending a monitor's performance report to a subscriber.

### BACKGROUND OF THE INVENTION

Driver tracking is a long-standing problem with broad applications for parents, company and fleet vehicles, rental car agencies, and vehicle insurance carriers. All drivers, even those who actively practice driver safety face a range of challenges to safe driving. For example, existing road conditions around a driver, such as potholes, sharp curves, multi-way stops, animal crossings, road construction, poor roads, and factors resulting in a higher accident rate along a particular road can result in safety issues. Weather conditions, such as rain, snow, ice, fog, and conditions that cause black ice also create driving safety issues. Distracted driving includes any activity that could divert a person's attention away from the primary task of driving. All distractions endanger driver, passenger, and bystander safety. This problem exists for all types of driver: professional fleet drivers, non-commercial drivers who use a company vehicle for business, drivers of their own private vehicles, inexperienced drivers and teenaged drivers.

Numerous efforts have been undertaken to monitor vehicle risk over time. A variety of systems have been proposed for monitoring vehicle behavior to assess risk. Previous solutions do not provide an ability to reliably track individual drivers when they are operating a vehicle. For each of these functions, establishing the identity of a driver for a vehicle with multiple drivers can be highly relevant, for example for an insurance carrier to assess the assumed risk when insuring the vehicle. Fleet management, parents, and other owners each have a special interest concerning the safe operation of vehicles.

### SUMMARY OF THE INVENTION

According to an embodiment of the present invention, there is disclosed a system for monitoring the performance of a driver of a vehicle and sending a monitor's performance report to a subscriber. The system includes means for uploading one or more subscribers' account information to a data server machine, which contains a computer including a processor, non-transitory memory, a hard disk, a standard application interface and a database stored thereon. Further, the system includes means for issuing a unique vehicle identification code by the data server machine to each of the one or more subscribers. The system further includes means for uploading the monitor's performance report corresponding to the unique vehicle identification code to the data server machine. The system further includes means for notifying the subscriber of the monitor's performance report uploaded to the data server machine. Finally, the system includes means for making the performance report accessible to the subscriber.

According to another embodiment of the present invention, there is disclosed a method for monitoring the performance of a driver of a vehicle and sending a monitor's performance report to a subscriber. The method includes uploading one or more subscribers' account information to a data server machine, which contains a computer including a processor, non-transitory memory, a hard disk, a standard application interface and a database stored thereon. The method further includes issuing a unique vehicle identification code by the data server machine to each of the one or more subscribers. Further, the method includes uploading the monitor's performance report corresponding to the unique vehicle identification code to the data server machine.

Further, the method includes notifying the subscriber of the monitor's performance report uploaded to the data server machine. Finally, the method includes making the performance report accessible to the subscriber.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a schematic of the driver monitoring system, in accordance with the present invention.

FIG. 2 is a three-dimensional view of a vehicle with a vehicle identification code to be used in combination with the driver monitoring system, in accordance with the present invention.

FIG. 3 is a schematic of various embodiments of insurance uses in conjunction with the driver monitoring system, in accordance with the present invention.

FIG. 4 is a flow chart of the process by which a subscriber interacts with and utilizes the driver monitoring system, in accordance with the present invention.

FIG. 5 is a flow chart of the process by which a monitor interacts with and utilizes the driver monitoring system, in accordance with the present invention.

FIG. 6 is a flow chart showing the operation of the data server, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

Among the driving population are a large number of drivers who may benefit from active monitoring and assessment of their driving and their driving environment to detect and warn about dangerous driving situations. For example, active monitoring and assessment might be particularly beneficial to young drivers, new drivers, drivers hauling or carrying dangerous materials, drivers driving in unknown or dangerous locales, and drivers with a history of road rage, driving under the influence of drugs or alcohol, speeding, or other reckless operations. Further, distracted driving behavior relating to text messaging, email usage and web browsing which require visual, manual, and cognitive attention from the driver are very alarming distractions.

The driver monitoring system 10 is a system for monitoring the performance of a driver of a vehicle 11 and sending a monitor's performance (also called driving) report to a subscriber 12. Monitors 20, such as a person driving behind the vehicle 11, of the vehicle 11 may submit complimentary or critical reports of the driver's activities by referencing a specific vehicle identification code 18 unique to that vehicle 11 and preferably displayed on or near the rear of the vehicle, although the identification code 18 may be displayed anywhere on the vehicle 11 that the user desires. The monitoring system 10 enables the monitor 20 of the vehicle 11 to report the driver's activities to the subscriber 12 corresponding to vehicle 11. By providing a driver of any vehicle with a reminder that his driving activities are being watched by monitors 20 that may voice an opinion on his driving behavior, it will encourage the driver into making safer choices. If the subscriber 12 receives repeated, documented reports of driving problems associated with a particular driver, the subscriber will be more likely to take appropriate steps to correct pernicious driving activities.

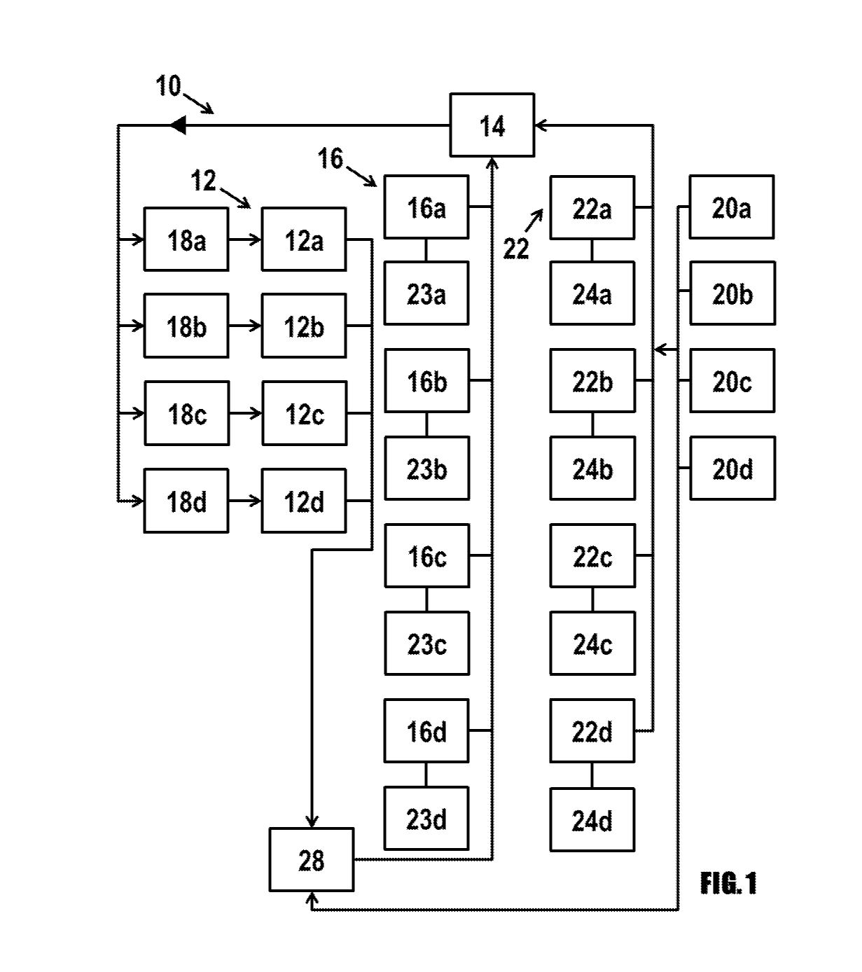

FIG. 1 illustrates an overall schematic view of the driver monitoring system 10. The tracking system 10 functions such that a plurality of subscribers 12, including any number such as 12a, 12b, 12c, and 12d (12a-12d), which upload contact information to a machine such as a data server 14, which contains a computer and a database, that is interconnected with a plurality of communication devices 16, including any number such as 16a, 16b, 16c, and 16d (16a-16d), each one linked to a specific subscriber.

The data server 14 issues a unique vehicle identification code 18, i.e. 18a, 18b, 18c, 18d, (18a-18d) to each subscriber 12a-12d. Typically, the identification codes are printed out on a printer connected to the data server and mailed to the subscriber. The identification codes can be printed on a substrate of paper, plastic, vinyl, or a magnetic material having the address of the subscriber so that it can be mailed directly to the subscriber without further handling of the substrate. The data server 14 receives driving information relating to a specific identification code from one of the plurality of monitors 20, including any number such as 20a, 20b, 20c, and 20d (20a-20d). Each of the monitors 20 is interconnected to the data server 14 through a specific communication device 22, including any number of monitors such as 22a, 22b, 22c, and 22d (22a-22d).

In a preferred embodiment, both the subscribers 12a-12d and the monitors 20a-20d use a vehicle monitoring application software 23 and 24 (hereafter “monitoring application”), respectively, with their smart phones or other mobile communications devices. The monitoring applications 23 and 24 each operate as a mobile application for smartphones and tablet devices and are installed into the smartphones or other mobile communications devices of each of the subscribers 12a-12d and the monitors 20a-20d, who are active within the driver monitoring system 10. Vehicle monitoring application software platforms 23 and 24 can be a single software system or two different software systems.

Initially, a subscriber 12, who wishes to utilize the driver monitoring system 10, downloads the monitoring application 23 onto his or her mobile communications device 16. These communications devices may include a handheld mobile device telephone, a computer tablet, a laptop computer, an electronic handheld information device such as a Personal Digital Assistant (PDA), or any other mobile communications device capable of sending and receiving data over a wireless network. In its operative configuration, the monitoring software application 23 is stored and operates on the mobile communications device 16. The mobile communications device allows the subscriber 12 to interact with the data server 14.

Each mobile communications device 16 may include a processor, network interface circuitry, and memory. The monitoring application 23 operates on a mobile software platform such as iPhone OS, Android OS, Palm Web OS, J2ME, Windows Mobile, Flash, Flash Mobile, or other similar mobile software platform. The individual mobile communications device 16 is connected to a wireless network, such as a commercial cellular data network, WiFi, or a WAN network. The operation of these various communication networks are well known and will not be described in greater detail.

After downloading the monitoring application 23, the subscriber 12 creates an account on the data server 14 through the software monitoring application 23, including contact information, credit card information, an associated vehicle or vehicles, and any other relevant information. After creating this account and authorizing payment, the subscriber 12 becomes a “member” of the driver monitoring system 10. It should be noted that while the subscriber 12 typically creates the account on the data server 14 through the monitoring application 23, it is also within the preferred embodiment to create an account directly on the data server 14 through a website 28 associated with the driver monitoring system 10. The website 28 provides a portal for each subscriber 12 to create an account on the data server 14. The website portal 28 also provides access to the monitors 20 who can report on a driver's activities directly through the website portal. After a monitor 20 submits a report through the data server 14, a notification of a report is sent to the subscriber 12, including a report of the vehicle 11 containing the vehicle identification code 18. This report may be sent to the subscriber via the monitoring application 24, the subscriber's email, a live or automated telephone call, or through a text message. It should be noted that the report of the vehicle 11 containing the vehicle identification code 18 may be sent directly to the police and to the subscriber's insurance company.

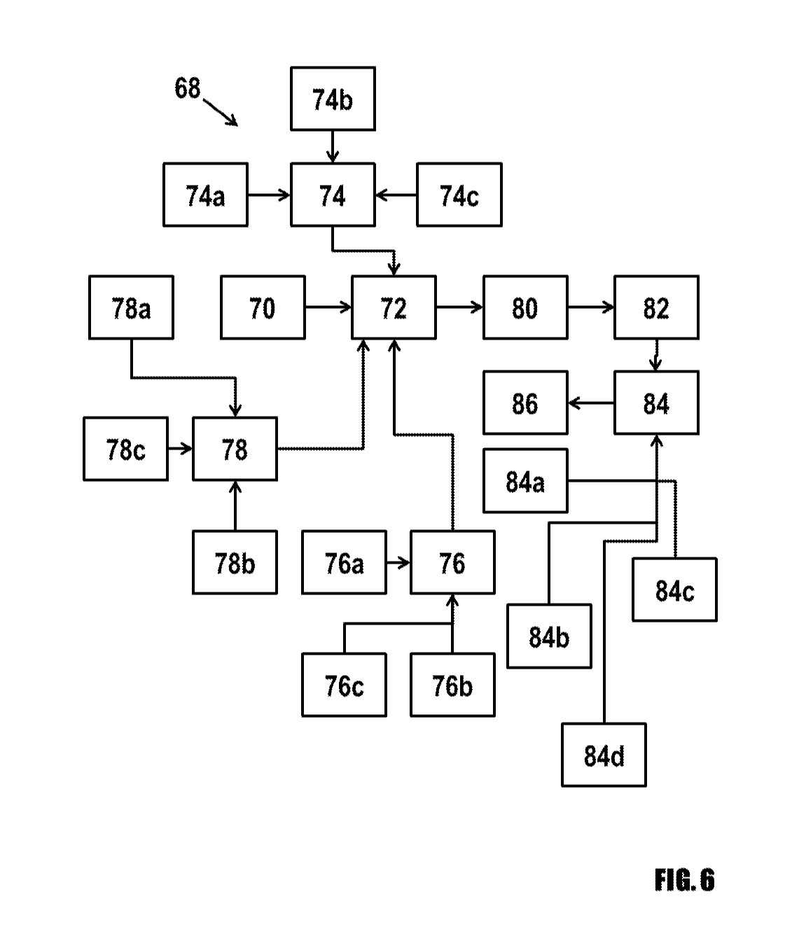

The data server 14 is a machine which may be a network-connected server computer system or set of computer systems that can be hosted by a web server or server farm. The data server machine 14 contains a computer including a processor, non-transitory memory, a hard disk, a standard application interface (API) and a database stored thereon. The database resides on the hard disk. The database can be continually updated by a synchronization function of the API which manages access to the database. The database is able to manage multiple concurrent access to and from the data server 14. Further, the data server 14 has the ability to print out information to allow a hard copy to be sent to a subscriber 12. The data server 14 provides subscription services to the subscribers 12 whereby it receives and processes the subscriber's information and payment. Later, when a report relating to the specific vehicle identification code 18 on a vehicle 11 is received, the data server 14 acts to notify the subscriber 12 and relay the report to the subscriber. Further, the data server 14 provides reporting capabilities to the monitors 20 of the driver monitoring system 10. The monitors 20 may add a performance report of a vehicle 11 with a vehicle identification code 18 to the data server 14, to be relayed to the subscriber 12. A description of the operation of the data server 14 with reference to FIG. 6 is provided hereinafter.

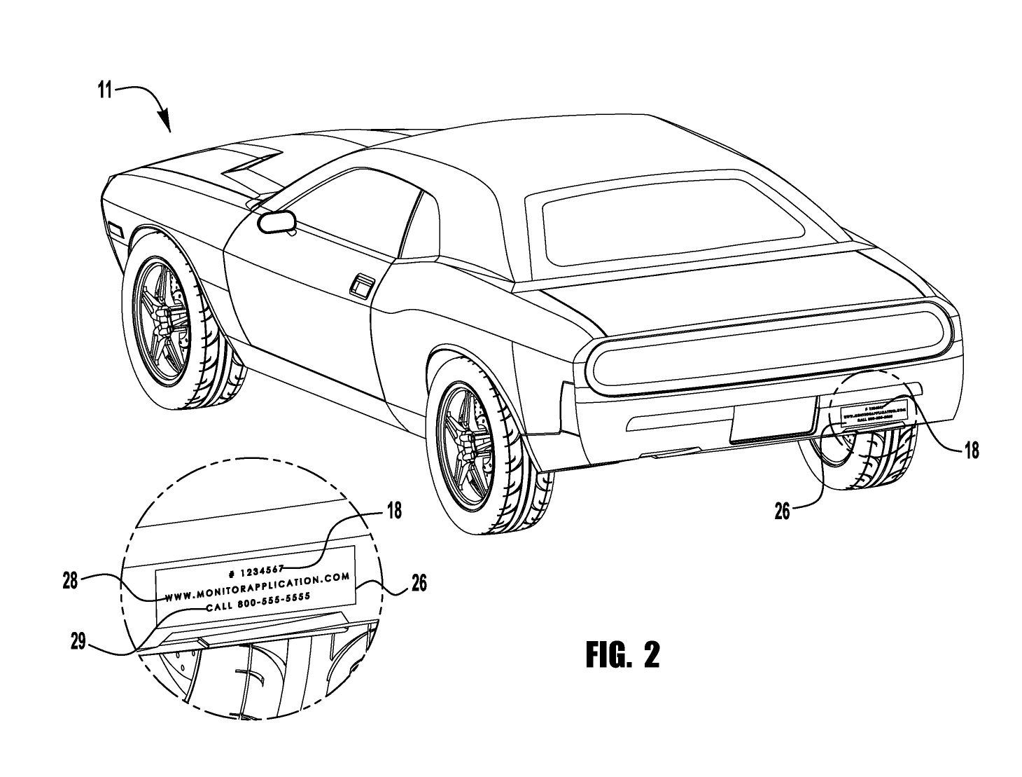

Upon a subscriber 12 completing an account on the data server 14, the server responds by issuing a specific vehicle identification code 18 to the subscriber 12. The vehicle identification code 18 is applied to a vehicle of the subscriber's 12 choosing. Most preferably, the vehicle identification code 18 is formed as a vehicle display 26 and is a permanent or temporary decal affixed by friction, magnetism, adhesive or other means whereby the display may be attached to the vehicle 11, as seen in FIG. 2. Displays 26 such as bumper stickers, window stickers, magnetized door signs, window decals and the like are well known to those of ordinary skill in the art and conventionally include a substrate of paper, plastic, vinyl, or a magnetic material having a message printed thereon. Such displays 26 may be formed in virtually any size or shape, It is contemplated that the vehicle display 26 may also be formed having a reflective surface to increase and enhance nighttime visibility and may be formed in various large and small formats.

Each vehicle display 26 includes the specific vehicle identification code 18, and any other desired information such as a website 28 or a telephone number 29 at which a monitor 20 may submit a report, or a logo that identifies the vehicle 11 as a component of the driver monitoring system 10. Preferably, the vehicle identification code 18 is no more than six characters to better enable a monitor 20 to remember the code when driving, though the use of greater numbers of characters, such as numbers, letters, and symbols, is contemplated as within the scope of the embodiment. It is within the terms of the embodiment that the identification code 18 be a QR code. The vehicle identification code 18 may be systematically or randomly assigned by the data server 14, or specifically selected by the subscriber 12. It is also contemplated that the identification code 18 may be placed on a license plate and include the number of the vehicle 11 on which the vehicle display 26 is to be placed. Further, it should be noted that the identification code 18 may simply be the license plate number of the vehicle 11. As described below, the monitor 20 may enter the identification code 18 into the monitoring application 24, or the website 28, along with a report on the driver's activities. It is also contemplated that as the notoriety of the driver monitoring system 10 grows, only a short message, such as a trademark, logo or other symbol or word which would invoke an association with the system and allow a monitor 20 to report using the vehicle's 11 license plate state and number.

A monitor 20 who wishes to participate in the driver monitoring system 10, downloads the monitoring application 24 onto his or her mobile communications device 22. These communications devices 22a-22d may include a handheld mobile device telephone, a computer tablet, a laptop computer, a PDA, or any other mobile communications device capable of sending and receiving data over a wireless network.

In its operative configuration, the software monitoring application 24 is stored and operates on the mobile communications device 22. The mobile communications device 22 allows the monitor 20 to interact with the data server 14. Although not required, the monitor 20 may have the option to create an account on the data server 14 through the monitoring application 24, including contact information, credit card information, an associated vehicle or vehicles, and any other relevant information.

It should be noted that while the monitor 20 typically creates and submits their report through the monitoring application 24 on their mobile communications device 22, it is also within the preferred embodiment to create and submit their report directly on the data server 14 through a website 28 associated with the driver monitoring system 10. The website portal 28 provides access to the monitors 20a-20d who can report on a driver's activities directly through the website portal. Alternatively, a telephone number may be provided such that a monitor 20 may call and submit a report.

It should further be noted that the driver monitoring system 10 may include a tracking system, such as a GPS tracking device. In this embodiment, the subscriber 12 may install the tracking system to the vehicle 11 and track it's location, speed, etc. through the monitoring application 23 or the website 28.

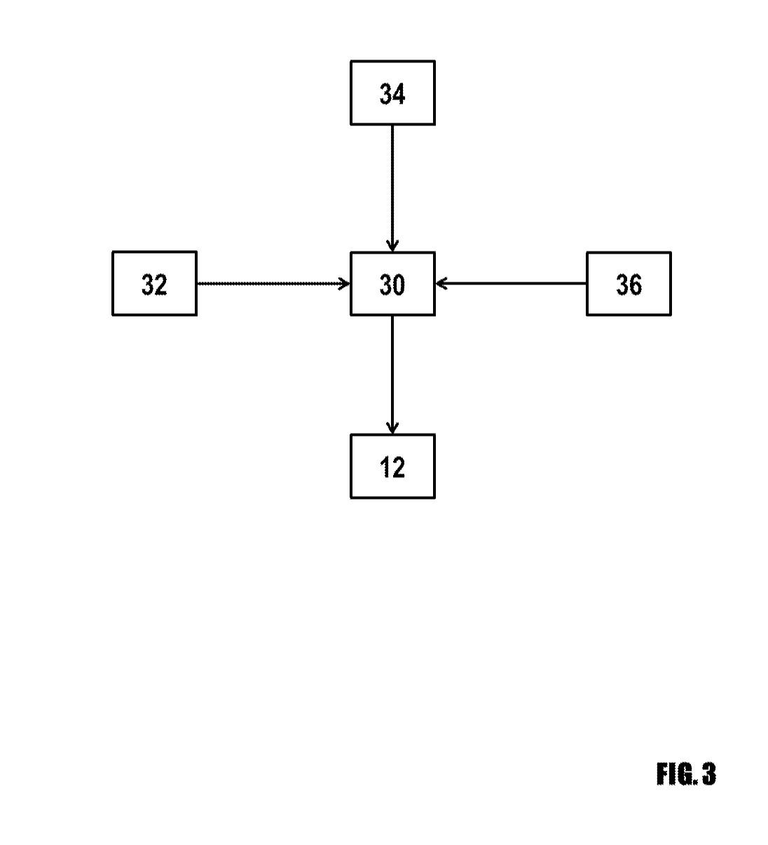

As seen in FIG. 3, it is within the terms of the embodiment that an insurance company 30 offers a discount on insurance premiums, or alternatively refunds the cost of subscribing to the monitoring system 10, when an insurer's vehicle displays a vehicle identification code 18 and reporting method as described earlier. According to one embodiment 32, an insurance company 30 of private passenger cars can offer insurance discounts to drivers who drive vehicles displaying a reportable vehicle identification code 18 and an indication of a reporting method such as an Internet address. According to a second embodiment 34, companies, groups or associations concerned with driving safety, such as consumer products or services sales companies, membership organizations and the like, offer promotional items, discounts or credits to vehicle owners who agree to display, or are already displaying, a reportable vehicle identification code 18 and indication of a reporting method. According to a third embodiment 36, insurance companies 30 provide the monitoring system 10 to insurance customers in return for a discount on the customer's insurance. The reports may then be directed to the insurance company 30 as well as the vehicle owner or may be directed solely to the insurance company. By directing the reports to the insurance company 30, the insurance company is ensured an opportunity to evaluate the reports for a particular driver or vehicle.

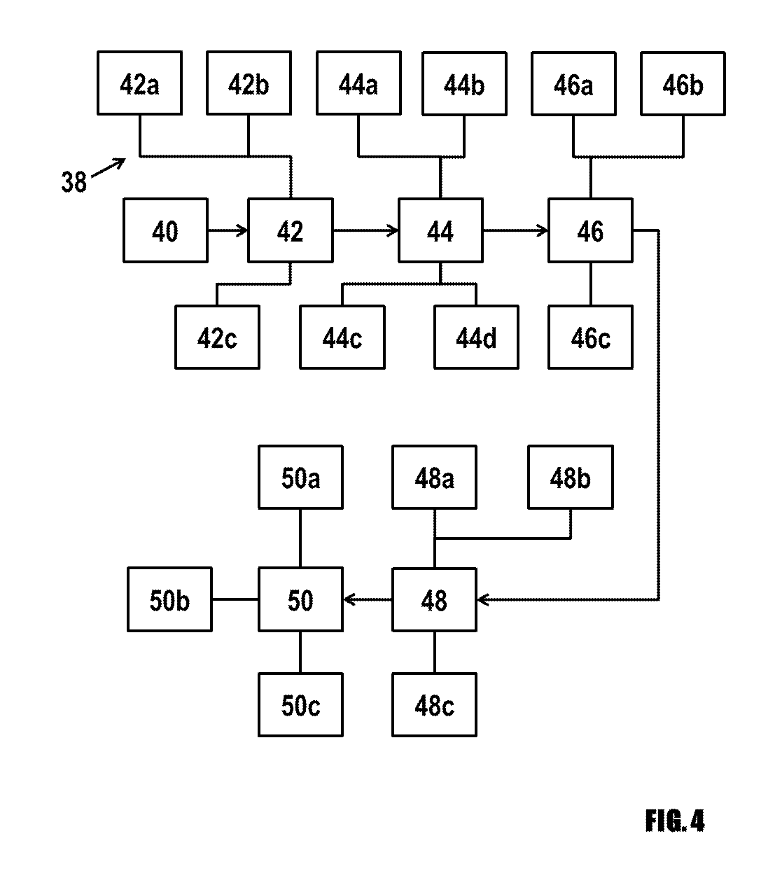

FIG. 4 is a flow chart illustrating the method 38 in which the subscriber 12 interacts with and utilizes the monitoring system 10. Note that FIG. 4 refers to the flow chart of FIG. 1.

In step 40, the subscriber 12 downloads the monitoring application 23 onto his or her mobile communications device 16, which may include a handheld mobile device telephone, a computer tablet, a laptop computer, a PDA, or any other mobile communications device capable of sending and receiving data over a wireless network.

In step 42, the subscriber 12 logs onto the monitoring application 23 with his or her mobile communications device 16. The monitoring application 23 will display information regarding the services provided and their cost 42a, vehicle accident statistics 42b, benefits 42c of utilizing the monitoring system 10, and any other desired information.

In step 44, the subscriber 12 creates an account on the data server 14 through the monitoring application 23. The subscriber 12 will enter his or her contact information 44a, credit card information 44b, an associated vehicle or vehicles 44c, length of subscription 44d and any other relevant information. After creating this account and authorizing payment, the subscriber 12 becomes a “member” of the driver monitoring system 10.

In step 46, the subscriber 12 will select the method by which he or she is notified of an incoming report or reports from the monitor 20. This may include notifications directly to the monitoring application 46a, notifications to the subscriber's email account 46b, notifications to the subscriber's telephone 46c, or any other desired form of notification.

In step 48, the subscriber 12 selects the regularity by which he or she receives the notifications, such as hourly 48a, daily 48b, weekly 48c, or any other desired manner.

In step 50, the subscriber 12 will select the method by which he or she will access or receive the report or reports from the monitor 20. This may include accessing the reports directly within the monitoring application 50a, receiving an email with the report 50b, receiving a live or automated telephone call 50c, or any other desired method.

It should be noted that while the subscriber 12 typically creates the account on the data server 14 through the monitoring application 23, it is also within the preferred embodiment to create, as shown in FIG. 1, an account directly on the data server 14 through a website 28 associated with the driver monitoring system 10. The website provides a portal for each subscriber 12 to create an account therein. The website portal also provides access to the monitors 20 who can report on a driver's activities directly through the website portal.

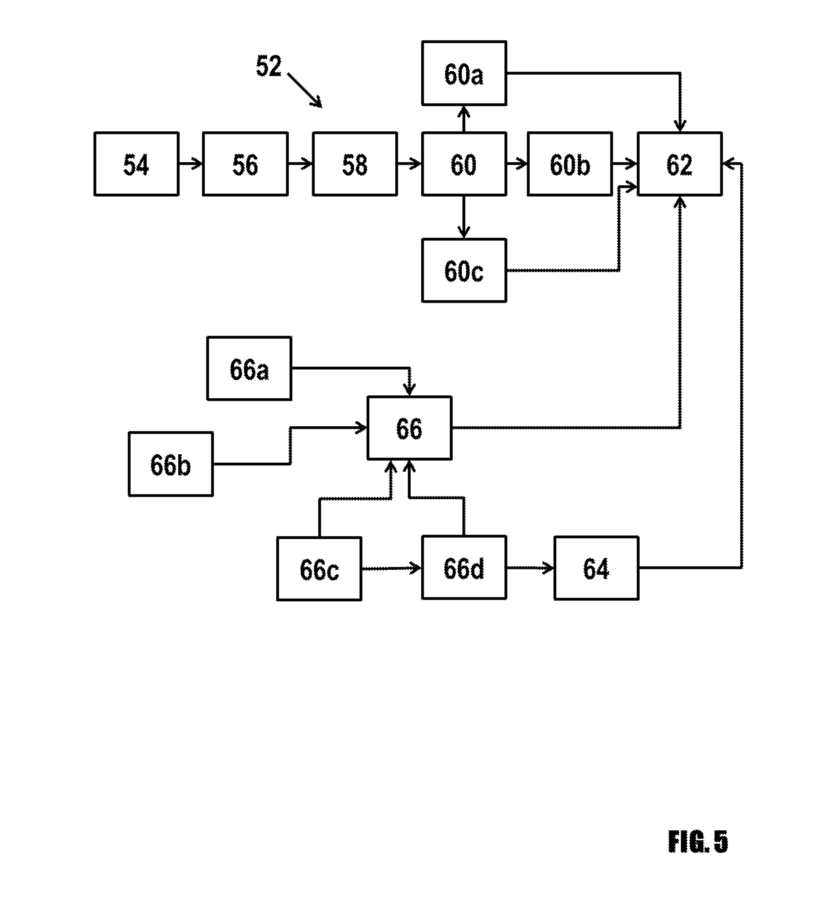

FIG. 5 is a flow chart illustrating the method 52 in which the monitor 20 interacts with and utilizes the monitoring system 10.

In step 54, the monitor 20 downloads the monitoring application 24 onto his or her communications device 22, typically a mobile communications device, which may include a handheld mobile device telephone, a computer tablet, a laptop computer, a PDA, or any other mobile communications device capable of sending and receiving data over a wireless network.

In step 56, although unnecessary, the monitor 20 has the option to create an account on the data server 14 through the monitoring application 24. The monitor 20 will enter his or her contact information 56a and any other relevant information.

In step 58, the monitor 20 witnesses a vehicle 11 with a vehicle identification code 18 and wishes to make a report about the driver of that vehicle.

In step 60, the monitor 20 submits a performance report relating to the vehicle with the identification code 18, which will ultimately be received by the subscriber 12. This may be accomplished by opening the monitoring application 24 on his or her mobile communications device 22, and submitting a monitoring report in step 60a. Alternatively, the vehicle display 26 includes the specific vehicle identification code 18, and any other desired information such as a website 28 or a telephone number 29. Therefore, in step 60b, the monitor may access the website 28 listed on the vehicle display 26 and submit a driving report. In step 60c, the monitor may call the telephone number 29 listed on the vehicle display 26 and submit a report.

In step 62, the monitor 20 has a variety of ways in which he may submit the driving report. These may include writing a written report and submitting it via the monitoring application 24 or website 28 in step 64. In step 66, the monitor 20 may select from a variety of prelisted driving offenses, such as texting while driving 66a, running a red light 62b, speaking on the phone 62c, speeding 66d, or any other desired offense.

Referring to FIG. 6, there is a flow chart showing the method 68 of operation of the data server 14. The data server 14 is a network-connected server computer system or set of computer systems that can be hosted by a web server or server farm.

In step 70, after the subscriber 12 has downloaded the monitoring application 23 onto his or her mobile communications device 16, the mobile communications device interconnects with the data server 14. The subscriber 12 creates an account on the data server 14, which can include uploading contact information, credit card information, an associated vehicle or vehicles, and any other relevant information to the data server. After creating this account and authorizing payment, the account information of the subscriber 12 is added to the database by the data server 14.

In step 72, data server 14 receives desired account preference information from the subscriber 12, including the method 74 by which the subscriber is notified of an incoming report or reports from the data server 14. This may include notifications directly to the monitoring application 74a, notifications to a user's email account 74b, notifications to a user's telephone 74c, or any other desired form of notification. Further, account preferences may include the regularity 76 by which the subscriber 12 receives the notifications, such as hourly 76a, daily 76b, weekly 76c, or any other desired manner. Further, the subscriber 12 will select the method 78 by which he or she will access or receive the report or reports from the data server 14. This may include accessing the reports directly within the monitoring application 78a, receiving an email with the report 78b, receiving a live or automated telephone call 78c, or any other desired method. All of the account information selected by the subscriber 12 will be entered into the database by the data server 14. It should be noted that the database of the data server 14 is able to manage multiple concurrent account creations and preferences simultaneously from a plurality of subscribers 12a-12d. In step 80, the data server 14 issues a specific vehicle identification code 18 to the subscriber 12, which may be systematically or randomly assigned by the data server 14, or specifically selected by the subscriber 12.

In step 82, the data server 14 will physically print and send the vehicle identification code 18, formed as a vehicle display 26. The vehicle display 26 is a permanent or temporary decal affixed by friction, magnetism, adhesive or other means whereby the display may be attached to the vehicle 11, as seen in FIG. 2. Displays 26 such as bumper stickers, window stickers, magnetized door signs, window decals and the like are well known to those of ordinary skill in the art and conventionally include a substrate of paper, plastic, vinyl, or a magnetic material having a message printed thereon.

In step 84, the data server 14 will receive a performance report relating to the vehicle 11 with the identification code 18 from a monitor 20. This performance report may be in the form 84a of a report from the monitoring application 24. Alternatively, the performance report may be through a website report 84b, a telephone call 84c, or text message 84d. Therefore, in step 60b, the monitor may access the website 28 listed on the vehicle display 26 and submit a driving report. In step 60c, the monitor may call the telephone number 29 listed on the vehicle display 26 and submit a report. It should be noted that the database is able to manage multiple concurrent reports simultaneously from a plurality of monitor 20a-20d.

In step 86, the data server 14 will access its database to determine the preferred notification process and method by which the subscriber 12 desires to receive the driving report. Then, the data server 14 will notify the subscriber 12 of the available performance report and make it accessible, based on the preferences of the subscriber.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A driver monitoring system for monitoring the performance of a driver of a vehicle and sending a monitor's performance report to a subscriber, comprising:
means for uploading one or more subscribers' account information to a data server machine, which contains a computer including a processor, non-transitory memory, a hard disk, a standard application interface and a database stored thereon;
means for issuing a unique vehicle identification code by the data server machine to each of the one or more subscribers;
means for uploading the monitor's performance report corresponding to the unique vehicle identification code to the data server machine;
means for notifying the subscriber of the monitor's performance report uploaded to the data server machine; and
means for making the performance report accessible to the subscriber.

2. The driver monitoring system of claim 1 including downloading vehicle monitoring application software onto the mobile communications devices of the one or more subscribers and one or more monitors.

3. The driver monitoring system of claim 2 wherein the vehicle monitoring application software operates as a mobile application for the mobile communications devices which include smartphones, tablet devices and tablet devices.

4. The driver monitoring system of claim 3 wherein the means for uploading one or more subscribers' account information to a data server machine includes uploading the account information to the data server machine through the vehicle monitoring application software on the one or more subscriber's mobile communications devices.

5. The driver monitoring system of claim 1 including means for the one or more subscribers to create an account directly on the data server machine through a website.

6. The driver monitoring system of claim 1 wherein the data server machine is a network-connected server computer system that is hosted by a web server.

7. The driver monitoring system of claim 6 wherein:
the data server machine includes a computer including a processor, non-transitory memory, a hard disk, a standard application interface and a database stored thereon;
and
the database can be continually updated by a synchronization function of the API which manages access to the database.

8. The driver monitoring system of claim 2 including means for the one or more monitors to download the monitoring software application onto their mobile communications device and create an account on the data server machine through the monitoring software application.

9. The driver monitoring system of claim 1 wherein the monitor uploads the monitor's performance report corresponding to the unique vehicle identification code to the data server machine through a website.

10. The driver monitoring system of claim 1 wherein the monitor uploads the monitor's performance report corresponding to the unique vehicle identification code to the data server machine through a telephone.

11. A method for monitoring the performance of a driver of a vehicle and sending a monitor's performance report to a subscriber, comprising:
uploading one or more subscribers' account information to a data server machine, which contains a computer including a processor, non-transitory memory, a hard disk, a standard application interface and a database stored thereon;
issuing a unique vehicle identification code by the data server machine to each of the one or more subscribers;
uploading the monitor's performance report corresponding to the unique vehicle identification code to the data server machine;
notifying the subscriber of the monitor's performance report uploaded to the data server machine; and
making the performance report accessible to the subscriber.

12. The method of claim 11 including downloading vehicle monitoring application software onto the mobile communications devices of the one or more subscribers and one or more monitors.

13. The method of claim 11 further including uploading the account information to the data server machine through the vehicle monitoring application software on the one or more subscriber's mobile communications devices.

14. The method of claim 11 including creating an account directly on the data server machine through a website with a portal for the subscriber to create an account therein.

15. The method of claim 14 further including issuing a specific vehicle identification code to the subscriber, such that the database physically prints and sends the vehicle identification code to the subscriber, formed as a vehicle display.

16. The driver monitoring system of claim 12 including downloading the monitoring software application onto the one or more monitors' mobile communications devices and creating an account on the data server machine through the monitoring software application.

17. The driver monitoring system of claim 12 including uploading the monitor's performance report corresponding to the unique vehicle identification code to the data server machine through a website.

18. The driver monitoring system of claim 12 including uploading the monitor's performance report corresponding to the unique vehicle identification code to the data server machine through a telephone.

19. The method of claim 12 further including accessing the database to determine the preferred notification process by which the subscriber desires to receive the performance report.

20. The method of claim 19 further including notifying the subscriber of the available performance report and make it accessible, based on the preferences of the subscriber.
